(19) United States
(12) Patent Application Publication
(10) Pub. No.: US 2026/0305574 A1
(43) Pub. Date: Oct. 8, 2026

(54) AI-POWERED SYSTEM FOR ANIMAL MANAGEMENT AND TRAINING INCLUDING AN ANIMAL WEARABLE OR IMPLANTABLE DEVICE

(71) Applicant: Wadi Gomero-Cure, Sarasota, FL (US)

(72) Inventor: Wadi Gomero-Cure, Sarasota, FL (US)

(21) Appl. No.: 19/098,743

(22) Filed: Apr. 2, 2025

(51) Int. Cl. A01K 15/02; A01K 11/00; A01K 29/00

(52) U.S. Cl. CPC A01K 15/02; A01K 11/008; A01K 29/005

(57) ABSTRACT

A wearable animal management and training device may include a housing configured to be affixed to or implanted into an animal; a processor disposed within the housing and operatively coupled to: a sensor suite including at least one of an audio sensor, visual sensor, motion sensor, temperature sensor, or environmental sensor; a stimulus mechanism configured to deliver at least one of an auditory, haptic, or electric stimulus to the animal; a communication module configured to wirelessly communicate with a remote server and other wearable devices; and a memory storing an artificial intelligence module executable by the processor to: monitor animal behavior in real time, analyze sensor data to detect patterns, generate behavior, modifying outputs via the stimulus mechanism, and adjust outputs based on individual animal responses and environmental factors.

### TECHNICAL FIELD

The embodiments generally relate to the technical field of computer-based animal management systems, and more specifically to artificial intelligence-powered wearable or implantable devices for livestock or pet monitoring, training, and control.

### BACKGROUND

Conventional animal management systems have traditionally relied on visual observation, human-led training methods, and basic tracking tools to oversee livestock and companion animals. Conventional systems often incorporate wearable devices such as collars or ear tags equipped with GPS modules or RFID chips to monitor animal location or identity. These systems may transmit data to a centralized hub for remote viewing or generate alerts when an animal exits a defined area. Some conventional solutions use auditory or haptic feedback to influence animal behavior, often relying on preset patterns or manual activation by a user.

Livestock monitoring systems typically gather metrics such as movement patterns, temperature, and feeding behavior, which farmers or veterinarians use to identify potential health or welfare concerns. These systems often operate on rule-based logic and require human interpretation of the collected data. In some cases, external software aggregates this information to provide trend reports or basic behavioral insights.

Pet training tools commonly include handheld remote-control devices that trigger audio signals, vibrations, or mild electric stimulation through collars. These tools generally depend on consistent human involvement and provide limited customization for individual animal temperament, breed, or context. Virtual fencing technologies have also emerged, allowing pet owners or livestock managers to define geographic boundaries digitally. When animals approach these boundaries, the devices initiate warning cues or corrective stimuli to guide movement.

While these systems offer valuable support in tracking, containment, and training, they often operate in isolation, lack adaptive decision-making, and depend heavily on user input for effective use. As a result, their functionality is limited to static rule sets, manual configuration, and reactive behavior management.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

A wearable animal management device may include a housing configured to be affixed to or implanted into an animal, and may contain a processor, a sensor suite, a stimulus mechanism, a communication module, and computing for an artificial intelligence (AI) module. The AI module may be configured to monitor animal behavior, analyze sensor data, generate behavior-modifying outputs, and adapt its responses based on individual animal characteristics, animal welfare needs, environmental factors, and owner/user needs.

The sensor suite may include one or more sensors, such as audio, visual, motion, temperature, thermal, LiDAR, Stereo Cameras, other computer vision technologies and other environmental sensors, to collect real-time data about the animal's condition and surroundings (including forage/grass quantity, quality-in the case of cattle). The stimulus mechanism may deliver auditory, haptic, or electric cues to influence or reinforce animal behavior (such as avoiding toxic or poisonous plants or calculating the appropriate virtual fence paddock size to efficiently graze grass-in the case of cattle. Or deter a dog from destructive behavior-in the case of dogs).

The communication module may wirelessly connect to other wearable devices or a cloud-based server, and may include long-range interfaces or operate through mobile relay stations in remote environments. The AI module may function with edge-processing capabilities, enabling the device to operate with varying levels of autonomy, including fully autonomous, semi-autonomous, or manual control.

In some implementations, the wearable device may incorporate a visual, auditory, and other environmental sensors for capturing data used in computer vision analysis. The AI module may identify behavioral trends, emotional states, environmental factors, and health-related changes, and may provide customized recommendations to users through a mobile application, chat bot, text message, telephone calls, or other user interface.

A system may be formed by a plurality of such AI-powered wearable devices functioning autonomously or in-sync with communication platforms such as wireless, satellite, or a cloud-based server. The system may aggregate data to generate insights at the individual animal or multi-animal level, coordinate behavioral instructions, and enable distributed AI powered behavior-modifying outputs among the devices. The server may also simulate digital twin models to forecast breeding, health, or movement scenarios, and may integrate external data sources such as weather, soil, and market information to enhance decision-making.

The system may support virtual fencing through GPS-defined boundaries that are dynamically adjustable based on environmental data, animal needs, and owner/user needs. Progressive stimuli may be applied as animals approach or cross boundaries. Historical movement data may be used for pasture rotation, regenerative agriculture optimization, and grazing analytics.

Additional features may include reproductive cycle tracking, predator detection, predator deterrence, behavioral modification for excessive barking or aggression, and the detection of toxic plant ingestion or environmental hazards. The system may initiate automated responses such as deploying drones or ground vehicles for inspection, protection, breeding, or animal herding.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a wearable device and corresponding systems in communication with the computing system, according to some embodiments;

FIG. 4 illustrates a wearable device, according to some embodiments; and

FIG. 5 illustrates a wearable device, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A wearable animal management device may include a housing configured to be affixed to or implanted into an animal, such as by being integrated into a collar, ear tag, harness, or other form of wearable or implantable devices such as Neurolink. The housing may be formed of weather-resistant materials suitable for continuous exposure to environmental conditions encountered by livestock or pets. The housing may be shaped and weighted to avoid interfering with the animal's normal movement or behavior. Or the housing may be formed of biocompatible materials for safe animal implantation.

Within the housing, a processor may be disposed and operatively coupled to various components. The processor may include an onboard microcontroller or system-on-chip capable of running embedded software and executing an artificial intelligence (AI) module. The processor may support edge computing functionality, allowing it to perform inference, algorithms, and training of models without reliance on a constant connection to a remote server.

A sensor suite may be operatively coupled to the processor. The sensor suite may include one or more of the following: an audio sensor (such as a microphone), a visual sensor (such as a camera, stereo cameras, infrared imaging module, or LiDAR), a motion sensor (such as a gyroscope or accelerometer), a temperature sensor, thermal imaging, or one or more environmental sensors (such as humidity, barometric pressure, or air quality sensors). These sensors may collect real-time data reflecting the animal's behavior, health, location, environment, needs, and condition.

The device may further include a stimulus mechanism configured to deliver an auditory, haptic, or electric stimulus to the animal. The auditory component may include a speaker or buzzer capable of generating tones, beeps, or recorded sounds or may include inaudible sounds targeted for specific animals or breeds. The haptic component may include a vibration motor. The electric stimulus component may include a low-voltage electrode pair designed to emit a mild shock signal from the wearable device onto the animal's skin or within an implanted device. Depending on the user's objectives, the animal stimulus mechanisms are initiated by the AI module in a fully autonomous mode (where the AI makes real-time decisions and executes actions autonomously), semi-autonomous mode (where the AI provides recommendations but requires human approval before execution) or manual mode (where AI offers insights and data but leaves all decisions to the user).

A communication module may be included to wirelessly communicate with a remote server or other wearable devices. The module may support short-and long-range wireless communication protocols, including but not limited to Bluetooth, Wi-Fi, LTE, LoRa, or satellite communication. In remote or low-signal environments, the communication module may interface with a mobile relay station that serves as an intermediary node to the cloud server.

A memory component, operatively connected to the processor, may store an AI module that enables various control and adaptation functionalities. The AI module may include software libraries or models configured for behavior tracking, reinforcement learning, environmental correlation, and animal response adaptation. The AI module may use sensor input data to generate a dynamic profile of the animal and adjust output stimuli accordingly. For example, the AI module may detect stress based on elevated heart rate, aggressive movement patterns, or abnormal temperature, and respond with calming stimuli.

The AI module may be a software component stored in the memory of the wearable or implantable animal management device and executed by the onboard processor. This module may be configured to analyze real-time sensor data, make behavioral or environmental determinations, and initiate corresponding outputs to influence or manage animal behavior. It may operate either locally on the device (edge computing) or in coordination with a cloud-based server, depending on the selected autonomy level and network availability. The AI module may include machine learning models trained on behavioral, environmental, and biometric data to recognize and predict specific animal states or responses. These models may be implemented using lightweight neural networks, decision trees, or reinforcement learning algorithms suitable for real-time execution on embedded processors. In operation, the AI module may process data received from a sensor suite that includes, for example, microphones, accelerometers, thermometers, cameras, stereo vision systems, LiDAR and other environmental sensors. From this data, the module may infer contextual insights such as movement patterns, health or nutrition needs, stress indicators, rest cycles, or emotional states. For example, through processed data received from the sensor suit, the AI module may detect restlessness, increased female movement, mounting behavior, and vocalization in a herd of cattle, which may lead the AI module to infer cow estrus and breeding behavior. This may trigger the AI module to initiate actions to optimize Bull and Cow breeding events on pasture. Upon detecting a behavioral pattern or condition, the AI module may generate a control signal to activate one or more stimulus mechanisms, such as audible tones, vibration, or low-voltage electrical pulses, to influence the animal's behavior. The intensity, duration, and type of stimulus may be dynamically adjusted based on the animal's response history and current context. This adaptive control may follow a reinforcement learning approach, in which the AI module modifies its strategy over time to maximize desired behavioral outcomes. The AI module may also store and update an individualized behavior profile for each animal. This profile may include historical health trends, responsiveness to stimuli, movement patterns, and contextual preferences. By tailoring outputs to each individual animal, the AI module may improve training precision, reduce stress, and facilitate consistent long-term behavior modification. In multi-animal deployments, the AI module may communicate learned insights or behavioral strategies across a network of devices. In this distributed learning mode, individual devices may share anonymized observations to accelerate group-level learning and synchronization. This approach allows the system to identify herd dynamics, prevent conflicts, and coordinate behaviors such as breeding, training, feeding, or movement. The AI module may also interface with cloud infrastructure to access supplemental data, such as weather forecasts, market trends, pasture condition maps, or veterinary guidelines, which may enhance its situational awareness and refine decision-making logic. For example, in preparation for an expected heatwave, the AI may adjust behavioral thresholds to prioritize hydration alerts and reduce training intensity. In some configurations, the AI module may support predictive functions using digital twin modeling. These models may simulate future behavioral or physiological scenarios based on current conditions and historical data. For instance, the AI system may halt potential breeding events based on suboptimal whether conditions to avoid calving during snowing seasons. The AI module may forecast grazing impact from manure and urine distribution on a pasture based on herd movement and forage density trends. Additionally, the AI module may generate user-facing recommendations through a companion application or other means of communication. These recommendations may include training guidance, feeding schedules, wellness alerts, or prompts to relocate animals within a virtual fencing system. For example, the AI system may influence movement of a dog into another room of the house when unfamiliar human visitors come to the house. The module may also adapt its behavior based on user-selected autonomy settings, which may define whether actions are executed automatically, proposed for confirmation, or limited to passive monitoring. The AI module may also identify and track biometrics such as heart rate (via PPG or thermal sensors), stress indicators (inferred from movement and environmental conditions), sleep cycles (via motion and sound inactivity), psychological state, and general animal welfare. The AI may learn each animal's routine and personalize feedback or alerts. Recommendations generated by the AI may be transmitted to a user via a mobile application, telephone, text, or web interface. These recommendations may include behavioral cues, exercise reminders, feeding schedules, breeding recommendation, grazing movements, or alerts relating to health, behavior, or safety concerns.

In some embodiments, the sensor suite may include a visual sensor such as a camera or stereo camera or LiDAR configured to capture two-dimensional and three-dimensional images or video. The captured images may be processed locally or sent to the cloud for further analysis using computer vision techniques. This capability may support visual animal identification, behavior recognition, assessment of animal condition or health, assessment of body weight, available animal resources, and environmental hazards.

In multi-animal settings, a system for managing a plurality of animals may include a distributed network of wearable devices as described above. Each device may share collected data with a cloud-based server. The server may aggregate and analyze the data to generate herd-level or multi-animal insights. These insights may relate to animal clustering, group stress, feeding synchrony, or behavioral anomalies. The server may then transmit device-specific behavioral instructions based on individual animal characteristics, animal welfare needs, environmental factors, and owner/user needs.

The wearable devices may support cooperative learning by sharing inference results or behavior-response mappings across multiple devices. This local exchange may enable distributed learning for edge computing, improving adaptability and reducing cloud reliance.

The server may also simulate digital twin models of each animal to predict future states or evaluate alternate scenarios. These simulations may assist in forecasting illness progression, breeding schedules, and pasture allocation strategies.

Third-party data sources, such as weather data, soil condition databases, or livestock market feeds, may be integrated by the server. These inputs may enhance the server's decision-making algorithms and help optimize management recommendations.

Each wearable device may allow a user to select between levels of autonomy. A fully autonomous mode may enable the AI to issue stimuli and responses without user intervention. A semi-autonomous mode may allow the AI to suggest actions that require user confirmation. A manual mode may limit the device to passive monitoring and require user input for action.

The AI system may be configured to initiate automated responses, such as deploying a drone or unmanned ground vehicle in response to detected anomalies, such as a predator. These automated tools may perform functions such as visual inspection, herding assistance, or deterrence of predators. Some automated tools (such as AI-controlled robotic toy ball) deployed by the AI-system may perform functions for training, grooming, caring, nurturing, and playing with animals.

The wearable or implantable devices may track reproductive indicators such as estrus cycles, and the server may use this data to initiate breeding-related actions, such as moving bulls to or away from selected females using virtual boundaries.

The AI module may also detect and deter specific behaviors such as excessive barking, destructive behavior, unwanted destructive chewing, or unwanted vocalization. Based on behavioral thresholds, the module may trigger a stimulus sequence such as sound, vibration, or low-voltage electric signal to reduce the undesired behavior.

A GPS module may be integrated into the device to enable location tracking and geofencing as part of a virtual boundary system. This system may be configured to define, monitor, and enforce virtual geographic boundaries, also referred to as geofences, without requiring physical fencing. It may guide animal movement and containment using behavioral stimuli instead of physical barriers.

The system may include a GPS module embedded within the wearable or implantable device. The GPS module may track the animal's position in real time using satellite signals and provide location coordinates to the processor. Based on these coordinates, the AI module may compare the animal's location to one or more stored or dynamically generated boundary zones. Boundaries may be defined by the user through interface with the AI, automatically generated by the AI system, or adjusted in response to user or animal needs. When an animal approaches a virtual boundary, the AI module may initiate a sequence of graduated animal stimuli through the stimulus mechanisms (auditory, haptic, electric) within the animal wearable device or implanted device. The sequence may begin with an auditory cue, such as a tone or beep; escalate to a haptic response, such as vibration; and, if necessary, culminate in a low-voltage electrical stimulus. This escalation protocol may be informed by reinforcement learning principles and personalized according to the animal's response history. For example, some animals may respond promptly to an auditory cue, while others may require a haptic or electric signal for effective redirection. The virtual boundary system may also support dynamic boundary adaptation. The AI module may modify boundary locations in response to real-time or predictive environmental data. For instance, if soil moisture sensors or external weather data indicate overgrazing risk or drought in a particular area, the system may shift boundaries to protect those regions and promote pasture recovery. Likewise, the system may rotate grazing areas in accordance with regenerative agriculture principles by scheduling rest periods and controlling animal access. In addition to enforcing containment, the virtual boundary system may coordinate animal movement. The AI may define directional flow patterns and sequence boundaries to guide animals toward specific areas, such as feeding stations, water sources, or shelter zones. This function may be implemented using progressive boundary movement or “herding” zones that migrate spatially across the pasture, prompting the animal to follow desired paths over time. In multi-animal settings, the system may assign different virtual zones to different animals or groups, enabling the separation of specific cohorts (e.g., lactating cows vs. heifers, bulls vs. breeding pairs) based on management objectives. The wearable or implantable devices may coordinate through peer-to-peer communication to avoid collisions, synchronize herd movement, or create buffer zones between animals that should not interact. Virtual boundaries may also be used in domestic environments. For example, the system may define indoor zones, such as keeping a dog out of a kitchen or away from a child's room. In such cases, the AI may rely on short-range localization technologies, such as Bluetooth beacons or Wi-Fi triangulation, in addition to GPS data. The system may log historical boundary crossings, time spent in defined zones, and movement patterns within the geofence. These data may be used to assess pasture utilization, monitor individual animal compliance, and inform future boundary placement. The historical data may also support pasture rotation planning and soil regeneration strategies by analyzing the frequency and intensity of land use. The virtual boundary system may further be integrated with autonomous or semi-autonomous machinery. For instance, when boundaries are shifted, the server may initiate the deployment of drones or unmanned ground vehicles to inspect fencing perimeters or guide animals into new zones. These robotic assistants may interact with the animals through light, sound, or motion to reinforce the AI's containment directives or reinforce animal training objectives. In some embodiments, the system may include visual feedback elements, such as LEDs mounted on the wearable device, to provide animals with an additional visual cue when approaching a boundary. These cues may enhance training effectiveness by associating boundary violation with multisensory feedback. The AI may define virtual boundaries using GPS coordinates and monitor animal proximity to these boundaries. As an animal approaches a boundary, the AI may trigger progressive stimuli to encourage directional movement away from the boundary. Boundary positions may be dynamically adjusted based on environmental monitoring data. For example, if soil moisture is low in one region of the pasture, the AI may shift the virtual boundary to promote rotational grazing and pasture recovery. The wearable or implantable device may also log movement history and transmit this data to the server to support analytics related to pasture wear, grazing impact, or animal productivity. Historical movement data may be used to build predictive models for pasture rest cycles or soil regeneration planning. The virtual boundary parameters may be adapted based on prior animal behavior, environmental conditions, and regenerative agriculture principles.

In some embodiments, the stimulus output may be escalated in a sequence, beginning with an auditory signal, then haptic vibration, and finally low, voltage electric stimulation (either externally in a wearable device or internally in an implanted device) if triggered by the AI, system.

The AI system may detect the presence of toxic plants or exposure to environmental hazards using environmental sensor data and other external inputs(For example, the AI system may use its various sensors to detect poisonous and potentially lethal plants near grazing sheep). Upon detection, the AI system may issue real, time alerts to a user interface for intervention, or trigger a coordinated robotic drone to destroy or deter potential hazards, or the AI system can influence animal movement away from potential hazards

Various implementations of the invention involve the technical field of computer, based animal management systems including an AI processor executing a machine learning algorithm for the control, training, management, breeding, nurturing, caring feeding, and movement of animal(s), Together, the components and software modules described above support a comprehensive animal management system powered by Artificial Intelligence, which is capable of sensing and analyzing an animals (or group of animals) physical condition as well as environmental condition, and then use its animal behavioral controls to train, manage, move, breed, control, and feed the animal or group of animals, across a variety of contexts. The AI effectuates it actions by triggering progressive stimuli and adjusts its triggers based on environmental and animal sensor data, including animal health, anticipated needs, soil condition, forage availability, or weather; wherein the system enables AI, driven stimuli for dynamic animal management and are therefore necessarily rooted in computer technology. For example, the aforementioned steps are inherently computer, based and cannot be performed in the human mind. Additionally, the steps of the present invention would be impossible to accomplish on pen and paper due to the volume of data being communicated and received over a network in real, time. In particular, the speed at which the steps of the present invention occur to effectuate the disclosed method, system, or product would involve large, scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present invention include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision, making, classification, or generating outputs based on inputs. In particular, the speed at which an artificial intelligence model analyzes and transforms data to effectuate the disclosed method, system, or product would involve large, scale, continuous transformation of such data. As such, the present invention would be impossible to accomplish on pen and paper or in the human mind due to the volume of data being analyzed and transformed by the artificial intelligence model.

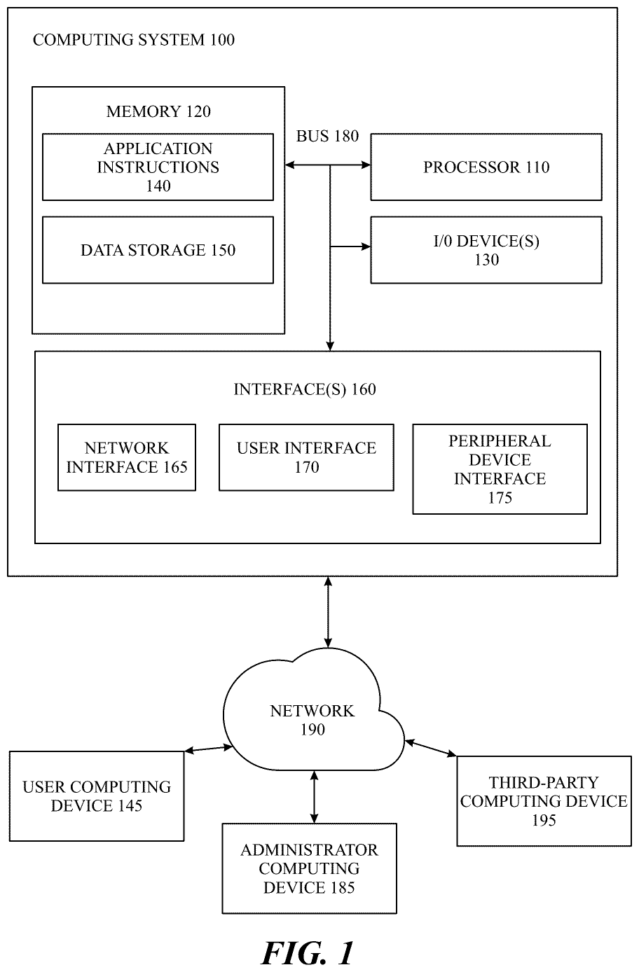

FIG. 1 illustrates an example of a computer system 100 that may be utilized to execute various procedures, including the processes described herein. The computer system 100 Comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer, readable media, which can program the processor(s) 110 to perform the functions described herein.

In this disclosure, the term “processor” can refer to substantially any computing processing unit or device, including single, core processors, single, processors with software multithreading execution capability, multi, core processors, multi, core processors with software multithreading execution capability, multi, core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano, scale architectures, such as molecular and quantum, dot based transistors, switches, and gates, to optimize space usage or enhance performance of user equipment. A processor can also be implemented as a combination of computing processing units.

In some embodiments, the memory 120 includes computer, readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non, exhaustive list of more specific examples of the computer readable storage medium can include: a portable computer diskette, a hard disk, a random access memory (RAM), a read, only memory (ROM), an erasable programmable read, only memory (EPROM or Flash memory), a static random access memory (SRAM), a portable compact disc read, only memory (CD, ROM), a digital versatile disk (DVD), a memory stick, a floppy disk, a mechanically encoded device such as punch, cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber, optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD, ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine, readable medium or computer, readable medium, which may be incorporated into a computer program product.

In some embodiments, the application instructions 140 for carrying out operations of the present disclosure can be assembler instructions, instruction, set, architecture (ISA) instructions, machine instructions, machine dependent instructions, microcode, firmware instructions, state, setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand, alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field, programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer, to, peer network (e.g., device to device Wi, Fi, Bluetooth, etc.), and/or an indirect peer, to, peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer, to, peer network. But when the first user device and the second user device are not near each other, the first user device and the second user device may exchange data using a peer, to, peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer, readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu, ray disc; in which “disks” usually reproduce data magnetically, and “discs” usually reproduce data optically with lasers. Combinations of the above should also be included within the scope of computer, readable media. In some embodiments, the computer, readable media includes volatile and nonvolatile memory and/or removable and non, removable media implemented in any type of technology for storage of information, such as computer, readable instructions, data structures, program modules, or other data. Such computer, readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer, readable media may be a type of computer, readable storage media and/or a tangible non, transitory media to the extent that when mentioned, non, transitory computer, readable media exclude media such as energy, carrier signals, electromagnetic waves, and signals per se.

In some embodiments, the system is world, wide, web (www) based, and the network server is a web server delivering HTML, XML, etc., web pages to the computing devices. In other embodiments, a client, server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on, demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on, demand self, service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug, in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third, party computing device 195 each in communication via the network 190. The user computing device 145 may be utilized by a user to interact with the various functionalities of the system. The administrator computing device 185 is utilized by an administrative user to moderate content and to perform other administrative functions. The third, party computing device 195 may be utilized by third parties to receive communications from the user computing device, transmit communications to the user via the network, and otherwise interact with the various functionalities of the system.

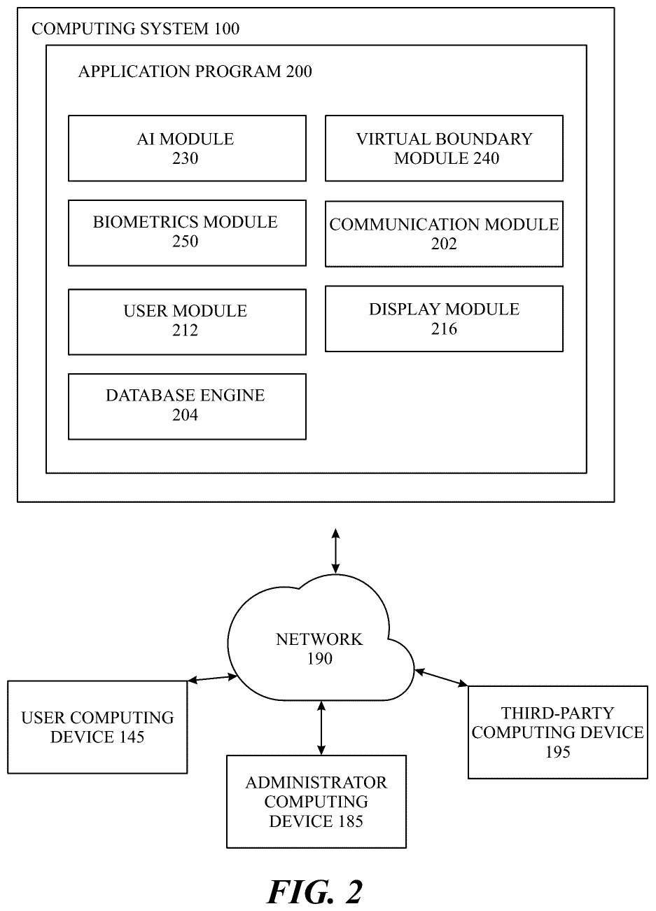

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of an AI module 230, a virtual boundary module 240, a biometrics module 250, a communication module 202, a database engine 204, a user module 212, and a display module 216.

In some embodiments, the AI module 230 is configured to analyze real, time data collected from one or more sensors associated with a wearable animal management device. The AI module 230 may include one or more machine learning models trained to identify behavioral patterns, emotional states, or environmental interactions based on multimodal inputs. These inputs may include motion data, biometric signals, environmental conditions, and audio or visual indicators. The AI module 230 may execute locally on an embedded processor within the wearable device, enabling real, time inference and decision, making without requiring constant network connectivity. In other embodiments, the AI module 230 may interface with a cloud, based server to supplement on, device processing or receive updated model parameters. The AI module 230 may support edge AI deployment frameworks and implement lightweight neural networks, decision trees, or reinforcement learning algorithms adapted for constrained computing environments. Upon detecting certain behavioral or physiological conditions, such as signs of stress, aggression, inactivity, or territorial encroachment, the AI module 230 may generate corresponding control signals to initiate behavioral responses through a stimulus mechanism. The module may escalate stimulus intensity based on prior animal responses, applying reinforcement learning techniques to improve training outcomes and ensure individualized animal engagement. The AI module 230 may further generate and maintain a dynamic behavioral profile for each animal. This profile may include time, series data on movement patterns, response history to stimuli, feeding habits, and environmental preferences. Over time, the AI module 230 may adapt its behavior, modifying outputs to align with each animal's unique temperament, routine, or health indicators. In some implementations, the AI module 230 is further configured to coordinate data exchange across a distributed network of animal, mounted devices. Devices may share learning outcomes or behavioral models, enabling localized cooperative learning among a group or herd. The AI module 230 may process this shared information to synchronize animal behaviors, detect anomalies at the group level, or implement herd, wide movement strategies. The AI module 230 may also interact with third, party data sources, such as weather forecasts, pasture health databases, or breeding schedules. These external inputs may influence the module's stimulus logic, movement recommendations, or virtual boundary adjustments. In certain scenarios, the AI module 230 may trigger predictive modeling functions using digital twin simulations of individual animals or the overall herd to support proactive decision, making. Additionally, the AI module 230 may be configured to issue real, time alerts, training cues, and health notifications to a user interface, such as a mobile application or web dashboard. These outputs may be tailored based on user, selected autonomy levels, ranging from manual control to fully autonomous operation, allowing end users to determine the degree of AI intervention in daily animal management tasks.

In some embodiments, the virtual boundary module 240 is configured to define, manage, and enforce virtual geographic boundaries for one or more animals using data received from a GPS module and other sensors integrated into a wearable device. These boundaries may be stored locally on the device or retrieved from a cloud, based server and may be presented as geospatial coordinates defining containment zones, movement corridors, or exclusion areas. The virtual boundary module 240 may compare the real, time location of an animal to one or more predefined or dynamically generated virtual zones. When the animal approaches or crosses a boundary threshold, the virtual boundary module 240 may initiate a behavioral response by transmitting control signals to the stimulus mechanism of the wearable device. The stimulus response may follow a progressive escalation protocol, beginning with an auditory alert, followed by haptic feedback, and escalating to a low, voltage electric stimulus, based on proximity to the boundary and past animal response patterns. In some configurations, the virtual boundary module 240 is further configured to adjust the size, shape, or position of virtual boundaries in response to environmental inputs. These inputs may include soil moisture levels, forage availability, weather conditions, or herd density metrics. By dynamically modifying geofence parameters, the virtual boundary module 240 may promote rotational grazing, preserve vulnerable pasture areas, or prevent overutilization of land. The virtual boundary module 240 may also coordinate virtual movement patterns across a herd or group of animals. In these scenarios, boundaries may shift gradually over time to encourage animals to move in a desired direction, toward a feeding station, away from a hazard, or into a new grazing zone. The module may synchronize such movement across multiple devices using peer, to, peer communication or cloud, sourced instructions. In certain implementations, the virtual boundary module 240 is configured to operate in indoor or signal, limited environments using short, range localization technologies such as Bluetooth beacons, Wi, Fi triangulation, or inertial navigation. These technologies may supplement or replace GPS data when satellite positioning is unavailable. The virtual boundary module 240 may further record and analyze historical boundary interactions, such as the number of breaches, time spent near thresholds, or avoidance patterns. These data may be used by the AI module to adapt future boundary enforcement strategies or by system administrators to evaluate grazing pressure, compliance, or environmental impact. In some embodiments, the virtual boundary module 240 may be integrated with automated support systems, such as drones or unmanned ground vehicles. Upon boundary reconfiguration or violation, the module may initiate deployment of these systems to assist in herding, inspection, or deterrence operations. The virtual boundary module 240 may also interface with a visual feedback component, such as a wearable LED indicator, to provide animals with a visual cue when near a boundary. This feature may support multimodal training and reinforce boundary awareness without relying solely on tactile or auditory stimuli.

In some embodiments, the biometrics module 250 is configured to monitor, analyze, and record physiological and behavioral data related to individual animals with an implanted device or a wearable device. This module may be operatively connected to one or more biometric sensors embedded within the device, including but not limited to heart rate monitors, temperature sensors, accelerometers, gyroscopes, LiDAR, ultrasound, and microphones. The biometrics module 250 may receive continuous or periodic sensor data and apply filtering or preprocessing algorithms to extract meaningful biometric indicators. These indicators may include heart rate variability, body temperature trends, sleep cycles, locomotion patterns, feeding rhythms, body condition scores, and stress, related behaviors such as excessive pacing or vocalization. In some implementations, the biometrics module 250 is configured to infer secondary health and wellness indicators by combining raw sensor inputs. For example, a combination of elevated temperature, abnormal motion patterns, and decreased activity may be interpreted as a potential sign of illness or injury. Similarly, sudden changes in heart rate coupled with restlessness may signal a stress event or environmental disturbance. The biometrics module 250 may maintain an individualized biometric profile for each animal. These profiles may evolve over time as the system observes changes in the animal's baseline patterns and behaviors. The module may compare new sensor readings to historical baselines to detect anomalies or shifts in physical condition. In certain embodiments, this analysis may trigger alerts or recommendations transmitted to a user interface or mobile device. In some embodiments, the biometrics module 250 is further configured to detect reproductive cues such as estrus onset or calving readiness. These cues may be identified through characteristic activity patterns, recorded breeding events, temperature shifts, or hormone, correlated behaviors. Upon detection, the system may initiate preconfigured responses such as adjusting virtual boundaries, notifying caretakers, or initiating pairing protocols with other animals. The biometrics module 250 may also share its outputs with the AI module 230 to influence stimulus delivery, behavioral modification strategies, or virtual boundary adaptations. For example, if the biometrics module 250 indicates that an animal is fatigued or overheated, the AI module may suspend or reduce training stimuli until recovery is detected. In herd, based deployments, biometric data from multiple animals may be aggregated and analyzed to identify population, level trends, such as heat stress during extreme weather, widespread illness onset, or group behavioral synchrony. These insights may be used to adjust environmental conditions, feeding schedules, or animal groupings. The biometrics module 250 may optionally interface with external health databases or veterinary systems to cross, reference observed indicators with known diagnostic patterns. In such cases, the module may contribute to automated early warning systems or predictive modeling for livestock health and performance. In some implementations, the biometrics module 250 is also configured to support visual display or export of collected biometric trends over time. These data visualizations may help end users understand animal health trajectories, understand breeding outcomes, record animal genealogy, identify deviations from norms, or correlate physiological changes with training activities or environmental events.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third, party computing device 195 of FIG. 1. In some embodiments, the communication module 202 is configured to allow one or more users of the system, including a third, party, to communicate with one another. In some embodiments, the communications module 202 is configured to maintain one or more communication sessions with one or more servers, the administrative computing device 185 of FIG. 1, and/or one or more third, party computing device(s) 195 of FIG. 1. In some embodiments, the communication module 202 may allow users and administrators to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others.

In some embodiments, the display module 216 is configured to display one or more graphic user interfaces, including, e.g., one or more user interfaces. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

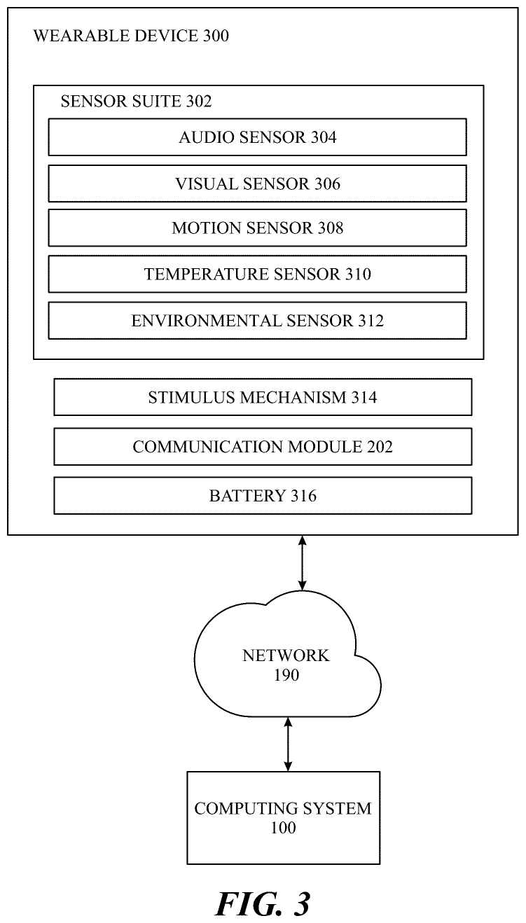

FIG. 3 illustrates a system, level block diagram of the animal management system architecture, according to some embodiments. The system includes a computing system 100 operatively connected via a network 190 to at least one wearable device 300 configured to be affixed to an animal. The wearable device 300 comprises a sensor suite 302 that may include multiple types of sensors for monitoring animal behavior and environmental conditions. The sensor suite 302 may include, but is not limited to, an audio sensor 304 (e.g., microphone), a visual sensor 306 (e.g., camera or infrared imaging device), a motion sensor 308 (e.g., accelerometer or gyroscope), a temperature sensor 310, and one or more environmental sensors 312 (e.g., humidity, air quality, or barometric pressure sensors). The wearable device 300 further includes a stimulus mechanism 314, which may be configured to deliver one or more behavioral stimuli to the animal, such as an auditory tone, vibration, or mild electrical pulse. The stimulus mechanism 314 may be triggered by control signals from an AI, driven logic component based on sensor data analysis or virtual boundary interactions. Also included is a communication module 202, which may support wireless communication between the wearable device 300 and the computing system 100 over the network 190. The communication module 202 may be configured for various wireless technologies such as Bluetooth, Wi, Fi, LTE, or LoRa. A battery 316 is provided to supply electrical power to the various subsystems within the wearable device 300. The battery 316 may be rechargeable and may interface with power management circuitry to support continuous operation in remote or unattended environments. Collectively, the components illustrated in FIG. 3 support the device's ability to collect animal, and environment, related data, process the data using local or remote computing resources, deliver adaptive stimuli to influence behavior, and maintain bi, directional communication with other system components.

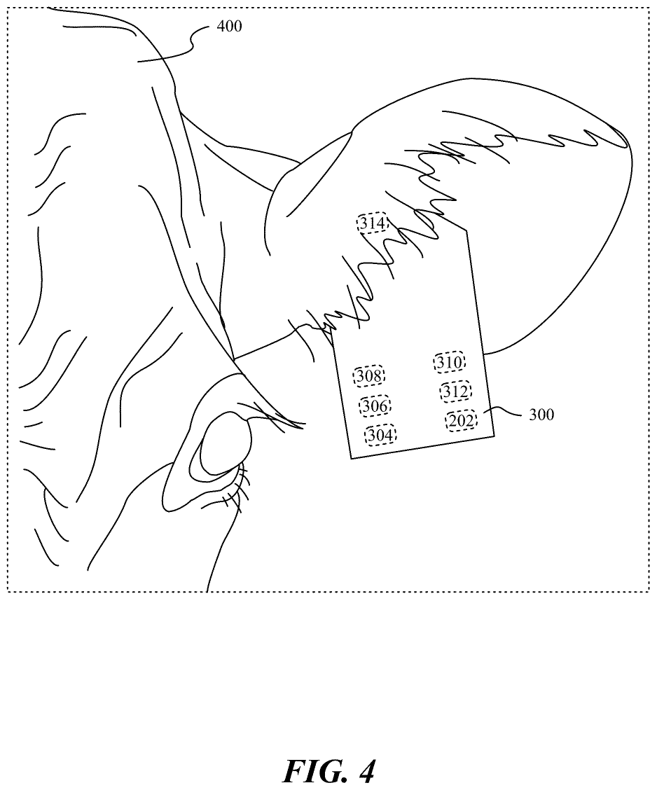

FIG. 4 illustrates a schematic view of a wearable animal management device 300 and its internal components, according to some embodiments. The wearable device 300 may be enclosed within a housing configured for secure attachment to an animal, such as via a collar, ear tag, harness, or other form of wearable or implantable apparatus. As shown, the wearable device 300 is worn by or attached to animal 400 may include a plurality of sensors comprising a sensor suite. Specifically, an audio sensor 304 may be configured to detect animal vocalizations or environmental sounds. A visual sensor 306 may capture still images or video, which may be used for computer vision, based analysis of behavior or surroundings. A motion sensor 308, such as an accelerometer or gyroscope, may monitor movement patterns and physical activity. A temperature sensor 310 may detect the animal's body temperature or ambient temperature. One or more environmental sensors 312 may be used to assess external conditions, including humidity, barometric pressure, or air quality. The device further includes a stimulus mechanism 314, which may provide behavioral stimuli such as auditory tones, haptic vibration, or low, voltage electric signals, based on control signals from an AI module executed by an onboard processor. A communication module 202 is also depicted within the wearable device 300 and may be configured for wireless communication with external computing systems or peer devices. This module may support the transmission of sensor data, reception of behavioral instructions, and participation in distributed AI learning or synchronization tasks. The device is powered by an internal battery 316, which supplies energy to all integrated electronic components. The battery 316 may be rechargeable and operatively coupled to energy management circuitry to optimize power usage during operation in field conditions.

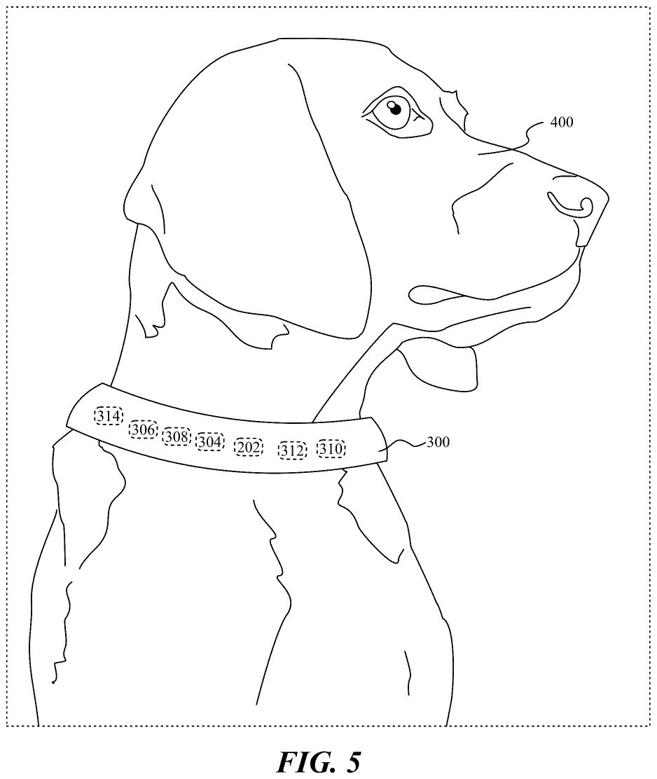

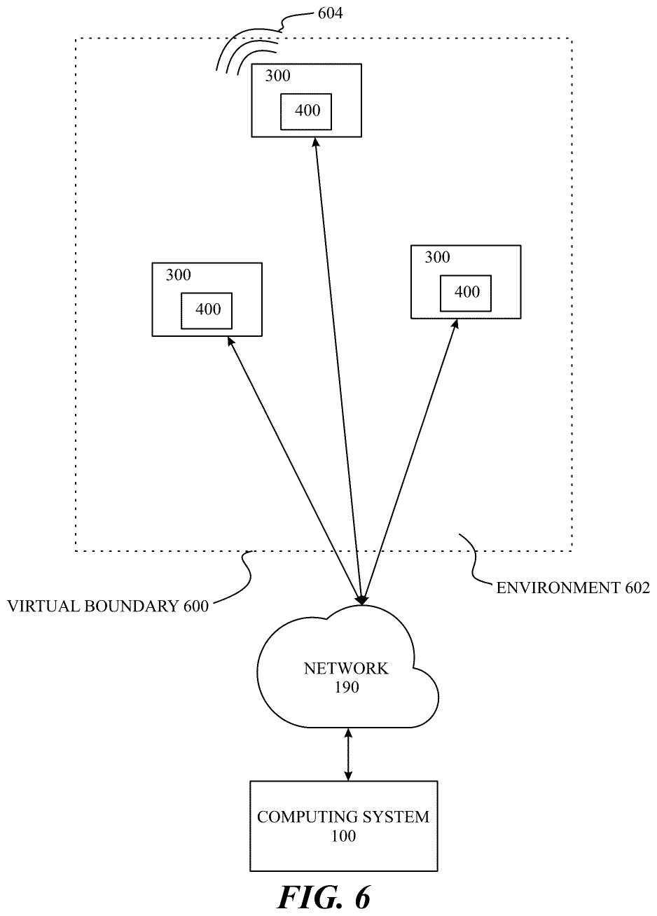

FIG. 5 illustrates a perspective view of wearable animal management device 300, worn by or attached to animal 400, according to some embodiments. Device 300 may include the same internal components described in connection with FIG. 4, including an audio sensor 304, a visual sensor 306, a motion sensor 308, a temperature sensor 310, one or more environmental sensors 312, a stimulus mechanism 314, and a communication module 202. These components collectively support real, time sensing, AI, based decision, making, behavioral stimulus delivery, and networked communication.

FIG. 6 illustrates the wearable animal management system operating in conjunction with a virtual boundary 600 in an operating environment 602, such as a pasture, according to some embodiments. The diagram shows multiple wearable devices 300 affixed to animals 400 within an open environment 602, in operable communication with a computing system 100 via a network 190. Each wearable device 300 may be configured to monitor the animal's real, time position and environmental conditions while receiving geospatial boundary definitions from the computing system 100. The system further includes a virtual boundary 600, representing a digitally defined geographic containment or exclusion zone within the environment 602. The virtual boundary 600 may be defined by a set of GPS coordinates or dynamically generated perimeter data, and may not require any physical fencing or markers to function. The boundaries may be individualized per animal or group, or applied globally across a herd. As animals approach or cross the virtual boundary 600, the wearable device 300 may trigger an adaptive response 604 sequence via its internal stimulus mechanism, such as an auditory tone, vibration, or low, voltage electric pulse. These responses 604 may be governed by the AI module 230 of FIG. 2 based on prior behavior, environmental factors, and learned feedback from the animal. The computing system 100 may coordinate communication between devices 300, store and adjust boundary 600 definitions, and transmit control signals to the wearable devices 300. The system may also log animal 400 movement relative to the virtual boundary 600 and adjust boundaries dynamically based on forage availability, soil condition, weather data, or pasture rotation schedules.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware, based system that performs the specified functions or acts or carry out combinations of special purpose hardware and computer instructions.

In this disclosure, the subject matter has been described in the general context of computer, executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer, implemented methods disclosed herein can be practiced with other computer system configurations, including single, processor or multiprocessor computer systems, mini, computing devices, mainframe computers, as well as computers, hand, held computing devices (e.g., PDA, phone), microprocessor, based or programmable consumer or industrial electronics, and the like. The illustrated embodiments can be practiced in distributed computing environments where tasks are performed by remote processing devices that are linked through a communications network. Some embodiments of this disclosure can be practiced on a stand, alone computer. In a distributed computing environment, program modules can be located in both local and remote memory storage devices.

In this disclosure, the terms “component,” “system,” “platform,” “interface,” and the like, can refer to and/or include a computer, related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull, down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A wearable animal management device comprising:
a housing configured to be affixed to or implanted into an animal;
a processor disposed within the housing and operatively coupled to:
a sensor suite including at least one of an audio sensor, visual sensor, motion sensor, temperature sensor, or environmental sensor;
a stimulus mechanism configured to deliver at least one of an auditory, haptic, or electric stimulus to the animal;
a communication module configured to wirelessly communicate with a remote server and other wearable devices; and
a memory storing an artificial intelligence module executable by the processor to:
monitor animal behavior in real time,
analyze sensor data to detect patterns,
generate behavior, modifying outputs via the stimulus mechanism, and
adjust outputs based on individual animal responses and environmental factors.

2. The device of claim 1, wherein the stimulus mechanism comprises at least one of: a sound generating speaker, a vibration motor, an LED light source, or a low, voltage electric stimulator, wherein the stimuli mechanisms are configured to:
prevent animals from entering restricted zones OR to entice animals to move to target areas;
ensures individualized, consistent, and effective training for pets and livestock;
provide customized training for household pets or working animals; and
modify animal behavior through reinforcement learning with beeping, vibration, lights, sounds, and controlled stimuli.

3. The device of claim 1, wherein the AI module is configured to track individual animal performance comprising body condition score, health, heart rate, stress indicators, sleep cycles, animal psychology, physiology, fertility, and activity levels.

4. The device of claim 1, wherein the AI module provides recommendations or triggers actions to achieve optimal animal management and training.

5. The device of claim 1, wherein the communication module includes a long, range communication interface configured to interface with a mobile relay station in remote environments.

6. The device of claim 1, further comprising a sensor suite comprising audio sensors, visual sensors, motion sensors, temperature sensors, or environmental sensors configured to capture data for computer vision, based analysis of animals and their environment and conducts real, time evaluations of pastures, environments, animals, and potential hazards.

7. The device of claim 6, wherein the device is configured to detect estrus cycles and automatically initiates animal segregation or proximity pairing to manage breeding events.

8. The device of claim 6, further comprising an AI module configured to detect excessive vocalizations or unwanted behaviors and initiate a stimulus sequence to reduce barking or other disruptive behavior.

9. The device of claim 8, wherein the AI module is further configured to:
monitors individual animal weight, body condition, health, activity, signs of injury, and behavior;
monitors dietary needs and suggests supplementation when required;
scan foods, pastures, and plants for contaminated, poisonous, or toxic feed via the sensor suite and emit, in response to detecting toxicity, emit an audible sound via one or more speakers in the device;
analyze animal movement, eating patterns, and body temperature to flag potential illnesses; and
in response to detecting a need for a predator deterrent, instruct the device to communicate an alert to a computing device, notify a drone, or emit an audible sound via the one or more speakers in the device.

10. A system for managing a plurality of animals, the system comprising:
a plurality of wearable animal management devices, each worn by a different animal;
a cloud, based server configured to:
receive data from the plurality of devices;
aggregate and analyze data to determine herd, level insights;
transmit behavioral or movement instructions to individual devices based on herd dynamics and environmental inputs;
wherein the wearable devices collectively form a distributed AI network with cooperative learning across the plurality of animals, and wherein each wearable device is configured to:
monitor fertility cycles and automates breeding events for genetic improvement;
track estrus cycles, pregnancy status, and calving predictions for optimal reproduction;
track mother, calf interactions and weaning efficiency; and
use data, driven genetic selection to enhance herd quality.

11. The system of claim 10, wherein each wearable device includes adjustable autonomy settings selected from fully autonomous, semi, autonomous, or manual.

12. The system of claim 10, wherein the server initiates automated deployment of unmanned aerial or ground vehicles in response to detected threats or as tools for training and behavior modification.

13. The system of claim 10, wherein the AI network is configured to sync automatic pet feeders to maintain hydration and meal schedules.

14. An autonomous animal control and monitoring system comprising:
at least one wearable device configured to be affixed to or implanted into an animal, the device comprising:
a GPS module;
a stimulus output system;
a processor executing a machine learning algorithm that:
detects proximity to virtual geographic boundaries defined by GPS coordinates or defined by AI generated virtual boundary zones
triggers progressive stimuli as the animal approaches or crosses the boundaries, and
adjusts boundary definitions based on environmental monitoring data, animal behavior, user needs, and environmental factors;
wherein the system enables AI, driven virtual fencing for dynamic pasture management.

15. The system of claim 14, wherein AI, driven virtual fencing comprises a location, based subsystem integrated into the at least one wearable device and controlled by an AI module or AI generated virtual boundary zones.

16. The system of claim 14, wherein the boundaries are adjusted based on soil data and forage density to promote rotational grazing to enhance forage harvest efficiency or feed efficiency depending on animal needs.

17. The system of claim 15, wherein the wearable device records and transmits pasture utilization data to facilitate pasture recovery, analytics and soil regeneration tracking, monitors manure distribution, monitors grazing behavior to prevent overgrazing based on sensor data, and monitors weather event data to adjust stocking rates and pasture rotation based on the weather event data.

18. The system of claim 15, wherein the virtual boundaries are defined dynamically by the AI based on prior grazing data and predictive pasture recovery modeling.

19. The system of claim 15, wherein the stimulus output is escalated from auditory to haptic to electric based on proximity threshold violations or behavior adjustment goals and the stimulus output is modified based on individual animal learning curves.

20. The system of claim 15, wherein the device is configured to detect toxic plant or other potential hazards and issue real, time alerts and actions accordingly.
